(19) United States
(12) Patent Application Publication
(10) Pub. No.: US 2026/0275127 A1
(43) Pub. Date: Sep. 17, 2026

(54) THERMALLY EXPANDABLE COMPOSITIONS WITH REDUCED ODOR EMISSION

(71) Applicant: SIKA TECHNOLOGY AG, Baar (CH)

(72) Inventors: Angela MACIEJEWSKI, Sterling Heights, MI (US); Julie SHERMAN, Bloomfield Hills, MI (US)

(73) Assignee: SIKA TECHNOLOGY AG, Baar (CH)

(21) Appl. No.: 19/472,395

(22) PCT Filed: Jun. 6, 2024
(86) PCT No.: PCT/EP2024/065674

§ 371 Date: Oct. 3, 2025

(30) Foreign Application Priority Data
Jun. 9, 2023 (EP) 23178450.5

(51) Int. Cl. C09D 5/26; C09D 7/61; C09D 7/63; C09D 7/65; C09D 109/06

(52) U.S. Cl. CPC C09D 5/26; C09D 7/61; C09D 7/63; C09D 7/65; C09D 109/06

(57) ABSTRACT

A thermally expandable composition including at least one solid rubber, at least on tackifying resin, azodicarbonamide, zinc oxide and at least one metal salt of a fatty acid AMS containing 16 C-atoms or 18 C-atoms, wherein the metal is zinc. A baffle element including the thermally expandable composition, to a method for sealing and/or baffling a cavity or a hollow structure, and to use of azodicarbonamide, zinc oxide and at least one metal salt of a fatty acid AMS in a thermally expandable composition including for decreasing the odor formation after heating the thermally expandable composition.

### TECHNICAL FIELD

The invention relates to thermally expandable compositions and use thereof for providing baffle elements. Such elements are suitable for use in sealing and/or baffling of hollow structures, for example cavities in a hollow structural part of an automotive vehicle.

### BACKGROUND OF THE INVENTION

Manufactured products often contain orifices and cavities or other hollow parts that result from the manufacturing process and/or that are designed into the product for various purposes, such as weight reduction. Automotive vehicles, for example, include several such orifices and cavities throughout the vehicle, including in the vehicle's structural pillars and in the sheet metal of the vehicle doors. It is often desirable to seal such orifices and cavities to minimize noise, vibrations, fumes, dirt, water, humidity, and the like from passing from one area to another within the vehicle by means of sealing members built into the orifice or cavity.

Elements used for sealing or baffling often consist of a carrier, made of plastic, metal, or another rigid material, and one or more layers of a thermoplastic material attached to it which is able to expand its volume when heat or another physical or chemical form of energy is applied, but they can also be entirely made of expandable material. Using an adequate design, it is possible to insert the baffle element into the hollow part of the structure during the manufacturing process but also to leave the inner walls of the structure still accessible (or the cavities passable) by for example a liquid. For example, during the manufacture process of a vehicle, the hollow parts of a metal frame can still be largely covered by an electro-coating (“e-coat”) liquid while the baffle elements are already inserted, and afterwards during a heat treatment step, the expandable thermoplastic material of the baffle element expands to fill the cavities as intended.

Currently employed thermally expandable compositions, which are used for providing baffle elements often comprise an elastomeric or a thermoplastic polymer matrix that can be cross-linked by using suitable curing agents and one or more blowing agents. Most widely used chemical blowing agents in thermally expandable compositions include azodicarbonamide (also called azodicarboxamide or azobisformamide) and 4,4′-oxydibenzenesulfonyl hydrazide (abbreviated OBSH). Under activation conditions, such as elevated temperature, curing of the cross-linkable network takes place, while simultaneously the blowing agent decomposes and releases gases. This leads to the above-mentioned volume expansion and the formation of a stable foam. Examples of such systems are disclosed in DE 10 2011 080 223 A1.

One of the problems in connection with the established solutions described above is the fact that thermally expandable compositions using azodicarbonamide as a blowing agent can have the disadvantage of odor formation since azodicarbonamide is potential emitter of ammonia when exposed to higher temperature. Especially in the automotive industry, many manufacturers rely on the test method VDA 270 to determine the odor of materials used and demand for low-odor materials.

It is thus desirable to obtain a thermally expandable composition containing azodicarbonamide as a blowing agent that does not suffer from these limitations and leads to low odor formation during and after the foaming process.

### SUMMARY OF THE INVENTION

It is an object of the present invention to provide a thermally expandable composition that does not suffer from these limitations and leads to low odor formation during and after the foaming process.

Surprisingly, the present invention provides a solution to that problem by providing a thermally expandable composition as defined in claim 1.

The composition according to the present invention is particularly suitable to be used in a sealing or baffle element, for example in automotive applications. Further aspects of the present invention are subject of other independent claims. Preferred embodiments of the invention are subject of dependent claims.

### DETAILED DESCRIPTION OF THE INVENTION

The subject of the present invention is a thermally expandable composition comprising:
a) At least one solid rubber R,
b) At least one tackifying resin TR,
c) azodicarbonamide ADCA
d) zinc oxide ZnO
e) at least one metal salt of a fatty acid AMS containing 16 C-atoms or 18 C-atoms, wherein the metal is zinc, preferably the metal salt of a fatty acid AMS is zinc stearate,
   The weight ratio of the azodicarbonamide ADCA to the zinc oxide ZnO (ADCA/ZnO) is from 2.0-7.5.

The weight ratio of the azodicarbonamide ADCA to the metal salt of a fatty acid AMS (ADCA/AMS) is from 0.75-6.5.

Substance names beginning with “poly” designate substances which formally contain, per molecule, two or more of the functional groups occurring in their names. For instance, a polyol refers to a compound having at least two hydroxyl groups. A polyether refers to a compound having at least two ether groups.

The term “polymer” refers to a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “rubber” refers to any natural, synthetic, or modified high molecular weight polymer or combination of polymers, which is capable of recovering from large deformations, i.e. has elastic properties. Typical rubbers are capable of being elongated or deformed to at least 200% of their original dimension under an externally applied force, and will substantially resume the original dimensions, sustaining only small permanent set (typically no more than about 20%), after the external force is released. In particular, the term “rubber” designates rubbers that have not been chemically crosslinked. The term “chemically crosslinked” is understood to mean that the polymer chains forming the elastomer are inter-connected by a plurality of covalent bonds, which are mechanically and thermally stable.

The term “molecular weight” refers to the molar mass (g/mol) of a molecule or a part of a molecule, also referred to as “moiety”. The term “average molecular weight” refers to number average molecular weight (Mn) of an oligomeric or polymeric mixture of molecules or moieties. The molecular weight may be determined by gel permeation chromatography.

The term “glass transition temperature” (T_{g}) refers to the temperature above which temperature a polymer component becomes soft and pliable, and below which it becomes hard and glassy. The glass transition temperature (T_{g}) is preferably determined by dynamical mechanical analysis (DMA) as the peak of the measured loss modulus (G″) curve using an applied frequency of 1 Hz and a strain level of 0.1 The term “softening point” refers to a temperature at which a compound softens in a rubber-like state, or a temperature at which the crystalline portion within the compound melts. The softening point can be determined by ring and ball measurement conducted according to DIN EN 1238:2011 standard.

The term “room temperature” designates a temperature of 23° C.

The thermally expandable composition further comprises at least one solid rubber R. The term “solid rubber” designates in the present document rubbers that are solid at a temperature of 25° C. The amount of the solid rubber R in the thermally expandable composition is not subject to any particular restrictions. It is however preferred that the at least one solid rubber R is present in the thermally expandable composition in an amount of at least 1.5 wt.-%, more preferably at least 2.5 wt.-%, based on the total weight of the thermally expandable composition.

According to one or more embodiments, the at least one solid rubber R comprises 5-40 wt.-%, preferably 7.5-35 wt.-%, more preferably 15-25 wt.-% of the total weight of the thermally expandable composition.

The at least one solid rubber R is preferably selected from the group consisting of butyl rubber, halogenated butyl rubber, styrene-butadiene rubber (SBR), ethylene-propylene rubber (EPR), ethylene-propylene diene monomer rubber (EPDM), natural rubber, polychloroprene rubber, cis-1,4-polyisoprene, polybutadiene rubber, isoprene-butadiene rubber, styrene-isoprene-butadiene rubber, nitrile rubber, nitrile-butadiene rubber, and acrylonitrile rubber.

According to one or more embodiments, the at least one solid rubber R is selected from the group consisting of butyl rubber, halogenated butyl rubber, styrene-butadiene rubber (SBR), ethylene-propylene rubber (EPR), ethylene-propylene diene monomer rubber (EPDM), natural rubber, cis-1,4-polyisoprene, and polybutadiene rubber. Preferably, the solid rubber R is styrene-butadiene rubber (SBR).

Preferably, the at least one solid rubber R has an average molecular weight (Mn) of at least 100'000 g/mol, more preferably at least 125'000 g/mol and/or a Mooney viscosity (ML 1+4 at 100° C.) of not more than 150 MU, more preferably not more than 125 MU, even more preferably not more than 100 MU. The term “Mooney viscosity” refers in the present disclosure to the viscosity measure of rubbers. It is defined as the shearing torque resisting rotation of a cylindrical metal disk (or rotor) embedded in rubber within a cylindrical cavity. The dimensions of the shearing disk viscometer, test temperatures, and procedures for determining Mooney viscosity are defined in ASTM D1646-19a standard.

According to one or more embodiments, the at least one solid rubber R comprises at least one solid styrene-butadiene rubber R1. Generally, the expression “the at least one component X comprises at least one component XN”, such as “the at least one solid rubber R comprises at least one solid styrene-butadiene rubber R1” is understood to mean in the context of the present disclosure that the thermally expandable composition comprises one or more solid styrene-butadiene rubbers R1 as representatives of the at least one solid rubber R.

Preferably, the at least one solid styrene-butadiene rubber R1 is an emulsion-polymerized styrene-butadiene rubber. These can be divided into two types, cold rubber and hot rubber depending on the emulsion polymerization temperature, but hot rubbers (hot type) are preferred.

Preferably, the at least one solid styrene-butadiene rubber R1 has
a styrene content of 1-60 wt.-%, preferably 5-50 wt.-%, more preferably 10-40 wt.-%, even more preferably 15-40 wt.-%, still more preferably 20-35 wt.-% and/or
a Mooney viscosity (ML 1+4 at 100° C.) in the range of 15-150 MU (Mooney units), preferably 20-100 MU, more preferably 20-80 MU, even more preferably 25-60 MU.

Preferred solid styrene-butadiene rubbers R1 include pre-crosslinked styrene-butadiene elastomers, which are commercially available, for example, under the trade name of Petroflex® SBR 1009A, 1009S and 1018 elastomers, manufactured by Petroflex/Lanxess, using either rosin or fatty acids soaps as emulsifier and coagulated by the salt-acid method, and SBR 1009, 1009A, 1502, 1507, and 4503 elastomers, manufactured by Lion Elastomers, by hot emulsion polymerization with divinylbenzene.

The thermally expandable composition further comprises at least one tackifying resin TR.

The term “tackifying resin” designates in the present disclosure resins that in general enhance the adhesion and/or tackiness of a composition. The term “tackiness” refers in the present document to the property of a substance of being sticky or adhesive by simple contact, which can be measured, for example, as a loop tack. Preferred tackifying resins are tackifying at a temperature of 25° C. Such tackifying resins TR lead to good adhesion on metal substrates, especially oiled metal substrates, both before and after foaming of the thermally expandable composition. Tackifying resins typically have a relatively low average molecular weight (Mn), such as not more than 5'000 g/mol, in particular not more than 3′500 g/mol, preferably not more than 3'000 g/mol.

Preferably, the at least one tackifying resin TR has
a softening point measured by a Ring and Ball method according to DIN EN 1238:2011 in the range of 50-200° C., more preferably 65-175° C., even more preferably 70-165° C., still more preferably 75-150° C. and/or
an average molecular weight (Mn) in the range of 150-5'000 g/mol, more preferably 250-3′500 g/mol, even more preferably 350-2′500 g/mol and/or
a glass transition temperature (T_{g}) determined by dynamical mechanical analysis (DMA) as the peak of the measured loss modulus (G″) curve using an applied frequency of 1 Hz and a strain level of 0.1% of at or above 0° C., preferably at or above 15° C., more preferably at or above 25° C., even more preferably at or above 30° C., still more preferably at or above 35° C.

According to one or more embodiments, the at least one tackifying resin TR comprises 12-20 wt.-%, preferably 4-12 wt.-%, more preferably 6-10 wt.-%, of the total weight of the thermally expandable composition.

Suitable resins to be used as the at least one tackifying resin TR include synthetic resins, natural resins, and chemically modified natural resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable rosin esters to be used as the at least one tackifying resin TR can be obtained, for example, from reactions of rosins and polyhydric alcohol or polyol such as pentaerythritol, glycerol, dipentaerythritol, tripentaerythritol, trimethylol ethane, trimethylol propane, ethylene glycol, polyethylene glycol, 1,3-propanediol, 1,4-butanediol, 1,5-pentanediol, 1,6-hexanediol, trimethylene glycol, propylene glycol, neopentyl glycol, in the presence of acid or base catalyst.

Suitable terpene resins to be used as the at least one tackifying resin TR include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “synthetic resin” designates in the present document compounds obtained from the controlled chemical reactions such as polyaddition or polycondensation between well-defined reactants that do not themselves have the characteristic of resins. Monomers that may be polymerized to synthesize the synthetic resins may include aliphatic monomer, cycloaliphatic monomer, aromatic monomer, or mixtures thereof. Suitable aliphatic monomers may include C₄, C₅, and C₆ paraffins, olefins, and conjugated diolefins. Examples of aliphatic monomers or cycloaliphatic monomers include butadiene, isobutylene, 1,3-pentadiene, 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, and dicyclopentadiene. Examples of aromatic monomer include C₈, C₉, and C₁₀ aromatic monomers. Typical aromatic monomers include, styrene, alphamethyl styrene, vinyl toluene, methoxy styrene, tertiary butyl styrene, chlorostyrene, coumarone, and indene monomers including indene, and methyl indene, and combinations thereof.

Suitable synthetic resins to be used as the at least one tackifying resin TR include, for example, hydrocarbon resins, coumarone-indene resins, polyindene resins, polystyrene resins, vinyl toluene-alphamethyl styrene copolymer resins, and alphamethyl styrene resins.

The term “hydrocarbon resin” designates in the present document synthetic resins made by polymerizing mixtures of unsaturated monomers obtained from petroleum based feedstocks, such as by-products of cracking of natural gas liquids, gas oil, or petroleum naphthas. These types of synthetic hydrocarbon resins are also known as “petroleum resins” or as “petroleum hydrocarbon resins”. The hydrocarbon resins include also pure monomer aromatic resins, which are prepared by polymerizing aromatic monomer feedstocks that have been purified to eliminate color causing contaminants and to precisely control the composition of the product.

Examples of suitable hydrocarbon resins to be used as the at least one tackifying resin TR include C5 aliphatic resins, mixed C5/C9 aliphatic/aromatic resins, aromatic modified C5 aliphatic resins, cycloaliphatic resins, mixed C5 aliphatic/cycloaliphatic resins, mixed C9 aromatic/cycloaliphatic resins, mixed C5 aliphatic/cycloaliphatic/C9 aromatic resins, aromatic modified cycloaliphatic resins, C9 aromatic resins, as well hydrogenated versions of the aforementioned resins. The notations “C5” and “C9” indicate that the monomers from which the resins are made are predominantly hydrocarbons having 4-6 and 8-10 carbon atoms, respectively. The term “hydrogenated” includes fully, substantially and at least partially hydrogenated resins. Partially hydrogenated resins may have a hydrogenation level, for example, of 50%, 70%, or 90%.

Suitable hydrocarbon resins are commercially available, for example, under the trade name of Wingtack® series, Wingtack® Plus, Wingtack® Extra, and Wingtack® STS (all from Cray Valley); under the trade name of Escorez® 1000 series, Escorez® 2000 series, and Escorez® 5000 series (all from Exxon Mobile Chemical); under the trade name of Novares® T series, Novares® TT series, Novares® TD series, Novares® TL series, Novares® TN series, Novares® TK series, and Novares® TV series (all from RUTGERS Novares GmbH), and under the trade name of Kristalex®, Plastolyn®, Piccotex®, Piccolastic® and Endex® (all from Eastman Chemicals).

Preferably, the at least one tackifying resin TR comprises, more preferably is, at least one C5 aliphatic hydrocarbon resin, preferably having a softening point measured by a Ring and Ball method according to DIN EN 1238:2011 in the range of 65-165° C., more preferably 75-135° C., even more preferably 80-125° C., still more preferably 90-110° C.

The thermally expandable composition further comprises azodicarbonamide ADCA. Preferably, the azodicarbonamide has an average particle size of 1-30 μm, preferably 4-15 μm, more preferably 8-12 μm. Such azodicarbonamide is commercially available, for example, as products from the UNICELL-D series from Dongjin Semichem co., Ltd.

The thermally expandable composition preferably further contains at least one accelerator for the azodicarbonamide ADCA. Preferred accelerators are urea compounds, more preferred substituted ureas, selected more particularly from the list consisting of 3-(3-chloro-4-methylphenyl)-1,1-dimethylurea (chlortoluron), p-chlorophenyl-N,N-dimethylurea (monuron), 3-phenyl-1,1-dimethylurea (fenuron), 3,4-dichlorophenyl-N,N-dimethylurea (diuron), N,N-dimethylurea, N-isobutyl-N′,N′-dimethylurea and 1,1′-(hexane-1,6-diyl)bis(3,3′-dimethylurea). A particularly preferred accelerator is N,N-Dimethylurea.

Preferably, the accelerator for the azodicarbonamide ADCA is comprised in 0.1-4 wt.-%, more preferably 0.25-3.5 wt.-%, even more preferably 0.5-3 wt.-% of the total weight of the thermally expandable composition.

The thermally expandable composition further comprises zinc oxide ZnO.

The thermally expandable composition further comprises at least one metal salt of a fatty acid AMS containing 16 C-atoms or 18 C-atoms, wherein the metal is zinc.

Preferably, the at least one metal salt of a fatty acid AMS containing 16 C-atoms or 18 C-atoms, wherein the metal is zinc, is selected from the group consisting of zinc salt of a saturated fatty acid containing 16 C-atoms, zinc salt of an unsaturated fatty acid containing 16 C-atoms, zinc salt of a saturated fatty acid containing 18 C-atoms and zinc salt of an unsaturated fatty acid containing 18 C-atoms.

More preferably, the at least one metal salt of a fatty acid AMS containing 16 C-atoms or 18 C-atoms, wherein the metal is zinc, is selected from the group consisting of zinc salt of palmitic acid, zinc salt of palmitoleic acid, zinc salt of sapienic acid, zinc salt of stearic acid, zinc salt of oleic acid, zinc salt of elaidic acid, zinc salt of vaccenic acid, zinc salt of linoleic acid, zinc salt of linoelaidic acid and zinc salt of α-linoleic acid.

Most preferably, the at least one metal salt of a fatty acid AMS containing 16 C-atoms or 18 C-atoms, wherein the metal is zinc, is selected from the group consisting of zinc salt of palmitic acid, zinc salt of stearic acid, zinc salt of oleic acid and zinc salt of linoleic acid.

The most preferred metal salt of a fatty acid AMS is zinc salt of stearic acid (zinc stearate).

Surprisingly it was found that other metal salts of a fatty acid, namely calcium stearate or aluminum stearate, lead to insufficient expansion rates and increased values on the odor scale. This can be seen, for example in table 2 in the comparison of E1 with Ref.5, E1 with Ref.6 respectively.

The weight ratio of the azodicarbonamide ADCA to the zinc oxide ZnO (ADCA/ZnO) is from 2.0-7.5.

A ratio of less than 2 leads to insufficient expansion rates and increased values on the odor scale. This can be seen, for example in table 2 in the comparison of E4 with E5, E1 with E5 respectively. A ratio of more than 7.5 leads to insufficient expansion rates. This can be seen, for example in table 2 in the comparison of E1 with Ref.1.

Preferably, the weight ratio of the azodicarbonamide ADCA to the zinc oxide ZnO (ADCA/ZnO) is from 2.25-6.0, more preferably 2.75-5.5, most preferably 3.0-4.5. The preferred ratios are advantageous with respect to higher expansion rates and lower values on the odor scale. This can be seen, for example in table 2 in the comparison of E4 with E1, E1 with E5 and E4 with E5.

The weight ratio of ADCA/AMS is 0.75-6.5.

A ratio of less than 0.75 leads to increased values on the odor scale. This can be seen, for example in table 2 in the comparison of E1 with E2 and E3. A ratio of more than 6.5 leads to increased values on the odor scale. This can be seen, for example in table 2 in the comparison of E1 with Ref.2.

Preferably, the weight ratio of the azodicarbonamide ADCA to the metal salt of a fatty acid AMS (ADCA/AMS) is from 1.0-6.0, preferably 1.5-5.5, more preferably 2.5-4.5. The preferred ratios are advantageous with respect to higher expansion rates and lower values on the odor scale. This can be seen, for example in table 2 in the comparison of E1 with Ref.2, E2 and E3, or the comparison of E4 with E6.

It can be further preferred, if the weight ratio of the azodicarbonamide ADCA to the metal salt of a fatty acid AMS (ADCA/AMS) is from 2.5-4.0. This ratio is advantageous with respect to lower values on the odor scale. This can be seen, for example in table 2 in the comparison of E4 with E6.

It can be further preferred, if the weight ratio of the azodicarbonamide ADCA to the metal salt of a fatty acid AMS (ADCA/AMS) is from 4.0-5.5. This ratio is advantageous with respect to better adhesion at a curing temperature of 170° C. on HDG substrates. This can be seen, for example in table 2 in the comparison of E6 with E4.

It is further advantageous, if the weight ratio of the azodicarbonamide ADCA to the sum of the zinc oxide ZnO and the at least one metal salt of a fatty acid AMS (ADCA/(ZnO+AMS)) is from 0.75-6.5, preferably 1.0-6.0, more preferably 1.5-5.5, most preferably 2.5-4.5. The preferred ratios are beneficial with respect to higher expansion rates and lower values on the odor scale. This can be seen, for example in table 2 in the comparison of E4 and E7 with Ref.4.

It can be further preferred, if the weight ratio of the zinc oxide ZnO to the at least one metal salt of a fatty acid AMS (ZnO/AMS) is from 0.2-2.0, preferably 0.3-1.75, more preferably 0.5-1.5, most preferably 0.75-1.25. The preferred ratios are advantageous with respect to higher expansion rates and lower values on the odor scale. This can be seen, for example in table 2 in the comparison of E1 with E2 and E3 or in the comparison of E4 with E6.

It is further advantageous, if the weight ratio of the at least one solid rubber R to the azodicarbonamide ADCA is from 2.0-6.0, preferably 3.0-5.0, more preferably 3.5-4.5, most preferably 3.75-4.25.

The thermally expandable composition preferably further comprises a vulcanization system VS.

A large number of vulcanization systems based on elementary sulfur as well as vulcanization systems not containing elementary sulfur are suitable.

In case a vulcanization system based on elementary sulfur is used, the system preferably contains pulverulent sulfur, more preferably at least one sulfur compound selected from the group consisting of powdered sulfur, precipitated sulfur, high dispersion sulfur, surface-treated sulfur, and insoluble sulfur.

Preferred vulcanization systems based on elementary sulfur comprise 1-15 wt.-%, more preferably 5-10 wt.-% of pulverulent sulfur, preferably at least one sulfur compound selected from the group consisting of powdered sulfur, precipitated sulfur, high dispersion sulfur, surface-treated sulfur, and insoluble sulfur, based on the total weight of the vulcanization system.

According to one or more embodiments, the vulcanization system VS is a vulcanization system without elementary sulfur.

Preferred vulcanization systems without elementary sulfur comprise at least one vulcanization agent and optionally at least one organic vulcanization accelerator and/or at least one inorganic vulcanization accelerator.

Suitable vulcanization agents for vulcanization systems without elementary sulfur include, for example, organic peroxides, phenolic resins, bisazidoformates, polyfunctional amines, para-quinone dioxime, para-benzoquinone dioxime, para-quinone dioxime dibenzoate, p-nitrosobenzene, dinitrosobenzene, thiuram compounds, bismaleimides, dithiols, as well as vulcanization systems crosslinked with (blocked) diisocyanates.

Suitable organic vulcanization accelerators to be used in the vulcanization systems without elementary sulfur include thiocarbamates, dithiocarbamates (in the form of their ammonium or metal salts), xanthogenates, thiuram compounds (monosulfides and disulfides), thiazole compounds, aldehyde-amine accelerators, for example hexamethylenetetramine, and guanidine accelerators.

Suitable inorganic vulcanization accelerators to be used in the vulcanization systems without elementary sulfur include, for example, basic zinc carbonates.

According to one or more preferred embodiments, the vulcanization system VS is a vulcanization system without elementary sulfur containing at least one vulcanization agent selected from the group consisting of para-quinone dioxime, para-benzoquinone dioxime, para-quinone dioxime dibenzoate, p-nitrosobenzene, dinitrosobenzene, and thiuram compounds, preferably from the group consisting of para-quinone dioxime, para-benzoquinone dioxime, para-quinone dioxime dibenzoate, tetramethyl thiuram disulfide (TMTD), and tetrabenzylthiuram disulfide (TBzTD), preferably tetramethyl thiuram disulfide, and preferably further containing at least one organic vulcanization accelerator.

Preferably, the at least one organic vulcanization accelerator is selected from the group consisting of cyclohexylbenzothiazole sulfonamide, mercaptobenzothiazole sulfide (MBTS), diphenyl guanidine, and zinc dimethyldithiocarbamate.

Preferably, the vulcanization system VS without elementary sulfur comprises 1-15 wt.-%, more preferably 1.5-5 wt.-%, even more preferably 1.5-3.5 wt.-%, most preferably 1.5-3 wt.-% of the total weight of the thermally expandable composition.

According to one or more preferred embodiments, the vulcanization system VS without elementary sulfur comprises 65-95 wt.-%, preferably 75-90 wt.-% of at least one vulcanization agent, preferably selected from the group consisting of para-quinone dioxime, para-benzoquinone dioxime, para-quinone dioxime dibenzoate, tetramethyl thiuram disulfide (TMTD), and tetrabenzylthiuram disulfide (TBzTD), and 5-35 wt.-%, preferably 10-25 wt.-% of at least one organic vulcanization accelerator, preferably selected from the group consisting of cyclohexylbenzothiazole sulfonamide, mercaptobenzothiazole sulfide (MBTS), diphenyl guanidine, and zinc dimethyldithiocarbamate, all the proportions being based on total weight of the vulcanization system VS.

According to one or more embodiments, the thermally expandable composition further comprises at least one plasticizer PL, preferably selected from the group consisting of process oils and liquid polyolefin resins.

Preferably, the at least one plasticizer PL, if used, is present in the thermally expandable composition in an amount of not more than 35 wt.-%, preferably not more than 30 wt.-%, based on the total weight of the thermally expandable composition.

According to one or more embodiments, the at least one plasticizer PL comprises 10-35 wt.-%, more preferably 15-30 wt.-%, even more preferably 20-30 wt.-%, of the total weight of the thermally expandable composition.

Suitable process oils to be used as the at least one plasticizer PL include mineral oils and synthetic oils. The term “mineral oil” refers in the present disclosure hydrocarbon liquids of lubricating viscosity (i.e., a kinematic viscosity at 100° C. of 1 cSt or more) derived from petroleum crude oil and subjected to one or more refining and/or hydroprocessing steps, such as fractionation, hydrocracking, dewaxing, isomerization, and hydrofinishing, to purify and chemically modify the components to achieve a final set of properties. In particular, the term “mineral” refers in the present disclosure to refined mineral oils, which can be also characterized as Group I-III base oils according to the classification of the American Petroleum Institute (API).

Suitable mineral oils to be used as the at least one plasticizer PL include paraffinic, naphthenic, and aromatic mineral oils. Particularly suitable mineral oils include paraffinic and naphtenic oils containing relatively low amounts of aromatic moieties, such as not more than 25 wt.-%, preferably not more than 15 wt.-%, based on the total weight of the mineral oil.

The term “synthetic oil” refers in the present disclosure to full synthetic (polyalphaolefin) oils, which are also known as Group IV base oils according to the classification of the American Petroleum Institute (API). Suitable synthetic oils are produced from liquid polyalphaolefins (PAOs) obtained by polymerizing α-olefins in the presence of a polymerization catalyst, such as a Friedel-Crafts catalyst. In general, liquid PAOs are high purity hydrocarbons with a paraffinic structure and high degree of side-chain branching. Particularly suitable synthetic oils include those obtained from so-called Gas-To-Liquids processes.

Preferably, the at least one plasticizer PL comprises at least one process oil PL1, preferably selected from the group consisting of naphtenic and paraffinic mineral oils.

The term “liquid resin” refers in the present disclosure to a resin that flows at normal room temperature, has a pour point of less than 20° C. and/or a kinematic viscosity at 25° C. of 50'000 cSt or less.

Suitable liquid polyolefin resins to be used as the at least one plasticizer PL include, for example, liquid polybutene and liquid polyisobutylene (PIB). The term “liquid polybutene” refers in the present disclosure to low molecular weight olefin oligomers comprising isobutylene and/or 1-butene and/or 2-butene. The ratio of the C₄-olefin isomers can vary by manufacturer and by grade. When the C₄-olefin is exclusively 1-butene, the material is referred to as “poly-n-butene” or “PNB”. The term “liquid polyisobutylene” refers in the present document to low molecular weight olefin oligomers of isobutylene, preferably containing at least 75 wt.-%, more preferably at least 85 wt.-% of repeat units derived from isobutylene. Suitable liquid polybutenes and polyisobutylenes have an average molecular weight (Mn) of less than 10'000 g/mol, preferably less than 7′500 g/mol, more preferably less than 5'000 g/mol, even more preferably less than 3′500 g/mol, still more preferably less than 2′500 g/mol.

Suitable liquid polybutenes and polyisobutylenes are commercially available, for example, under the trade name of Indopol®, such as Indopol® H-300 and Indopol® H-1200 (from Ineos); under the trade name of Glissopal®, such as Glissopal® V230, Glissopal® V500, and Glissopal® V700 (from BASF); under the trade name of Dynapak®, such as Dynapak® poly 230 (from Univar GmbH, Germany); and under the trade name of Daelim®, such as Daelim® PB 950 (from Daelim Industrial).

Preferably, the thermally expandable composition further comprises at least one solid particulate filler F, preferably selected from the group consisting of ground or precipitated calcium carbonate, lime, calcium-magnesium carbonate, talcum, gypsum, barite, pyrogenic or precipitated silica, silicates, mica, wollastonite, kaolin, feldspar, chlorite, bentonite, montmorillonite, dolomite, quartz, cristobalite, calcium oxide, aluminum hydroxide, magnesium oxide, hollow ceramic spheres, hollow glass spheres, hollow organic spheres, glass spheres, functionalized alumoxanes, and carbon black. Preferred solid particulate fillers include both organically coated and also uncoated commercially available forms of the fillers included in the above presented list.

The at least one solid particulate filler F is preferably present in the thermally expandable composition in the form of finely divided particles. The term “finely divided particles” refers to particles, whose median particle size d₅₀ does not exceed 500 μm, preferably 350 μm, more preferably 150 μm. The term “median particle size d₅₀” refers in the present disclosure to a particle size below which 50% of all particles by volume are smaller than the d₅₀ value.

According to one or more embodiments, the at least one solid particulate filler F has a median particle size d₅₀ in the range of 0.5-150 μm, preferably 1-100 μm, more preferably 1-50 μm, even more preferably 1-25 μm, still more preferably 1-10 μm.

According to one or more embodiments, the at least one solid particulate filler F comprises at least one mineral filler selected from the list consisting of ground or precipitated calcium carbonate, lime, calcium-magnesium carbonate, talcum, gypsum, graphite, barite, silica, silicates, mica, wollastonite, and carbon black.

According to one or more embodiments, the at least one solid particulate filler F comprises 5-50 wt.-%, preferably 10-45 wt.-%, more preferably 12.5-40 wt.-%, even more preferably 15-35 wt.-% of the total weight of the thermally expandable composition.

Preferably, the thermally expandable composition further comprises at least one styrene block copolymer SC.

Suitable block copolymers SC include, particularly, block copolymers containing polystyrene and polybutadiene blocks and/or polyisoprene blocks. These materials are generally available as pure triblock copolymers, also known as SIS and SBS block copolymers, and as diblock copolymers (SI and SB block copolymers).

Furthermore, styrene block copolymers are also commercially available as mixtures of diblock and triblock copolymers. Suitable styrene block copolymers can have a linear, radial, or star structure, the linear structure being especially preferred.

According to one or more embodiments, the at least one styrene block copolymer SC comprises at least one styrene isoprene diblock (SI) and/or triblock (SIS) copolymer and/or at least one styrene-butadiene diblock (SB) and/or triblock (SBS) copolymer.

Suitable SI, SIS, SB, and SBS block copolymers are commercially available, for example from TSRC/Dexco under the trade name of Vector®, such as Vector® 4000-series, and from Kraton Polymers under the trade name of Kraton® D-series.

According to one or more embodiments, the at least one styrene block copolymer SC comprises 4-20 wt.-%, preferably 5-15 wt.-%, more preferably 6-10 wt.-%, of the total weight of the thermally expandable composition.

It is further preferred if the thermally expandable composition contains less than 5 wt.-%, preferably less than 2.5 wt.-%, more preferably less than 1 wt.-%, of at least one epoxy resin, preferably at least one liquid epoxy resin, based on the total weight of the thermally expandable composition.

Said liquid epoxy resins typically include liquid resins of the formula (I)

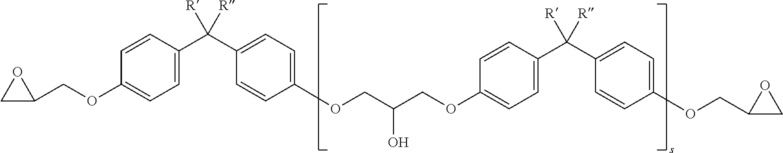

where R′ and R″ are each independently a hydrogen atom or a methyl group, and s has an average value of 0 to 1. Preference is given to those liquid resins of the formula (I) in which the index s has an average value of less than 0.2.

The liquid epoxy resins of the formula (I) are diglycidyl ethers of bisphenol A, bisphenol F and bisphenol A/F, where A represents acetone and F formaldehyde, which serve as reactants for preparation of these bisphenols. A bisphenol A liquid resin accordingly has methyl groups, a bisphenol F liquid resin hydrogen atom, and a bisphenol A/F liquid resin both methyl groups and hydrogen atoms, as R′ and R″ in formula (I). In the case of bisphenol F, it is also possible for positional isomers to be present, especially derived from 2,4′- and 2,2′-hydroxyphenylmethane.

It is further preferred if the thermally expandable composition contains less than 1 wt.-%, preferably less than 0.5 wt.-%, more preferably less than 0.1 wt.-%, of at least one polyvinylchloride (PVC) resin and/or acrylic resin, based on the total weight of the thermally expandable composition. The polyvinylchloride (PVC) resin can be a polyvinylchloride homo- or a copolymer, preferably a polyvinylchloride copolymer. The acrylic resin in the acrylic resin powder may be a homopolymer or a copolymer.

It is advantageous if the thermally expandable composition, besides the c) azodicarbonamide ADCA, is essentially free of physical and chemical blowing agents, preferably essentially free of chemical blowing agents. The expression “essentially free of” is understood to mean that the thermally expandable composition may contain only traces of said physical and chemical blowing agents other than azodicarbonamide ADCA, such as less than 0.25 wt.-%, preferably less than 0.15 wt.-%, more preferably less than 0.05 wt.-%, still more preferably less than 0.01 wt.-%, based on the total weight of the thermally expandable composition.

Preferably, the thermally expandable composition if essentially free, preferably free, of exothermic chemical blowing agents selected from the group consisting of OBSH, DNPT (dinitroso pentamethylene tetramine), PTSS (p-toluenesulfonyl semicarbazide), BSH (benzene-4-sulfonyl hydrazide), TSH (4-toluenesulfonyl hydrazide), and 5-PT (5-phenyltetrazole). The term “free of” is understood to mean that the amount of above listed compounds is 0 wt.-%, based on the total weight of the thermally expandable composition.

If is further preferred if the thermally expandable composition has a viscosity of more than 1000 Pa·s, preferably more than 2000 Pa·s, when measured by means of a rheometer with heatable plate (MCR 301, AntonPaar) (gap 1000 μm, measuring plate diameter: 25 mm (plate/plate), deformation 0.01-10% at 5 Hz, temperature: 20° C.).

If is further preferred if the thermally expandable composition is tacky at 23° C. The term “tacky” in this this document refers to a surface tack in the sense of instantaneous adhesion or stickiness that is preferably sufficient at 23° C. so that, when pressed with a thumb, exerting a pressure of 5 kg for 1 second on the surface of the thermally expandable composition, the thumb remains sticking to the surface of the thermally expandable composition. Preferably in this way, after the surface of the thermally expandable composition has been pressed with a thumb at 23° C., exerting a pressure of 5 kg for 1 second, a thermally expandable composition having an intrinsic weight of 50 g can be lifted up for at least 5 seconds.

According to one or more embodiments, the thermally expandable composition after curing has a volume increase compared to the uncured composition of not more than 1500%, preferably not more than 1000%, more preferably not more than 750%, whereby the volume increase is determined using the DIN EN ISO 1183 method of density measurement (Archimedes principle) in deionised water in combination with sample mass determined by a precision balance.

According to one or more embodiments, the thermally expandable composition after curing has a volume increase compared to the uncured composition in the range of 25-1000%, preferably 50-750%, more preferably 75-500%, even more preferably 100-500%.

The thermally expandable compositions according to the present invention can be produced by mixing the components in any suitable mixing apparatus, for example in a dispersion mixer, planetary mixer, double screw mixer, continuous mixer, extruder, or dual screw extruder.

Preferably, the at least one solid rubber R and the at least one plasticizer PL, if used, are mixed in a separate step using a kneader, preferably a sigma blade kneader until a homogenous mixture is obtained. This homogenous mixture is then preferably mixed with the remaining components of the thermally expandable composition in the suitable mixing apparatus mentioned above.

It may be advantageous to heat the components before or during mixing, either by applying external heat sources or by friction generated by the mixing process itself, in order to facilitate processing of the components into a homogeneous mixture by decreasing viscosities and/or melting of individual components. However, care must be taken, for example by temperature monitoring and use of cooling devices where appropriate, that the activation temperatures of the azodicarbonamide and optionally present vulcanization system VS are not exceeded during the mixing process.

The thermally expandable compositions according to the present invention obtained by using the process as described above are storage stable at normal storage conditions. The term “storage stable” refers in the present disclosure to materials, which can be stored at specified storage conditions for long periods of time, such as at least one month, in particular at least 3 months, without any significant changes in the application properties of the material. The “typical storage conditions” refer here to temperatures of not more than 60° C., in particular not more than 50° C.

Another subject of the present invention is a baffle element for open or hollow structures, wherein the element comprises the thermally expandable composition according to the present invention.

According to one or more embodiments, the thermally expandable composition of the baffle element has a sheet-like structure, preferably having
a thickness in the range of 0.5-10 mm, preferably 1-7.5 mm, more preferably 1-6 mm and/or
a width in the range of 1-30 cm, preferably 2-20 cm, more preferably 2-15 cm and/or
a length in the range of 5-30 cm, preferably 10-30 cm, more preferably 10-25 cm.

According to one or more further embodiments, the baffle element further comprises a carrier on which the thermally expansible composition is deposited or attached. Such a design may be more cost-efficient, and it may facilitate fixation of the baffle element on the walls of the structure to be baffled, for example by incorporation of pins, bolts, or hooks on the carrier element. Furthermore, with a suitable design of the carrier element, the mechanical performance and stability of the baffle element can be improved.

The carrier of the baffle element, if used, may consist of any material that can be processed into a shape. Preferred materials for the carrier include polymeric materials, such as a plastic, elastomers, thermoplastics, and blends thereof. Preferred thermoplastic materials include, without limitation, polymers such as polyurethanes, polyamides, polyesters, polyolefins, polysulfones, polyethylene terephthalates (PET), polyvinylchlorides (PVC), and chlorinated polyolefins. Especially preferred are high-temperature stable polymers such as poly(phenyl ethers), polysulfones, polyethersulfones, polyamides, in particular polyamide 6, polyamide 6,6, polyamide 11, polyamide 12, and mixtures thereof. Other suitable materials for the carrier include metals, especially aluminum or steel, or naturally grown, organic materials, such as wood or other (pressed) fibrous materials. Also, glassy or ceramic materials can be used. It is also possible to use any combination of such materials. It is also contemplated that such materials can be filled, for example, with fibers, minerals, clays, silicates, carbonates, combinations thereof, or be foamed.

The carrier can further exhibit any shape or geometry. It can also consist of several, not directly connected parts. For example, it can be massive, hollow, or foamed, or it can exhibit a grid-like structure. The surface of the carrier element can typically be smooth, rough, or structured, according to the intended use of the baffle element.

The baffle elements according to the present invention can produced, for example, by injection molding, punching or stamping, extrusion, calendering, or hot-pressing of the thermally expandable composition.

In case the baffle element comprises a carrier, the baffle element can be produced, for example, by a process, in which the thermally expandable composition is injection-molded onto a carrier or co-extruded with a carrier. The details of the manufacturing process of a baffle element comprising a carrier depend largely on the material of the carrier. If the material of the carrier can be (injection-) molded or extruded, the baffle element can be produced in a two-step injection-molding process or by co-extruding the carrier and the thermally expandable composition.

Preferably, the baffle element does not comprise a carrier and is tacky at 23° C. Such a baffle element can therefore be attached to the substrate, preferably a part of a cavity or a hollow structure, without the need of a carrier and/or fixation aid by simply sticking to the substrate by its tackiness.

Another subject of the present invention is a method for sealing and/or baffling a cavity or hollow structure, wherein a baffle element according to the present invention is introduced into said cavity or hollow structure and subsequently thermally expanded such that said cavity or hollow structure is at least partially filled by the expanded composition.

The temperature of the thermal expansion step is preferably 100-250° C., more preferably of 100-200° C., even more preferably 110-200° C., still more preferably 110-185° C. Preferred duration of the thermal expansion step, i.e. preferred baking time of the thermally expandable composition, is 5-90 min, more preferably 10-60 min, even more preferably 10-30 min.

According to one or more embodiments, the thermally expandable composition of the baffle element, upon activation, has a volume increase compared to its original unexpanded volume of 25-2000%, preferably 50-1500%, more preferably 75-1000%, even more preferably 100-750%, whereby the volume increase is determined using the DIN EN ISO 1183 method of density measurement (Archimedes principle) in deionised water in combination with sample mass determined by a precision balance.

Still another subject of the present invention is the use of azodicarbonamide ADCA, zinc oxide ZnO and at least one metal salt of a fatty acid AMS containing 16 C-atoms or 18 C-atoms, wherein the metal is zinc, preferably the metal salt of a fatty acid AMS is zinc stearate, in a thermally expandable composition comprising at least one solid rubber R and at least one tackifying resin TR; for decreasing the odor formation after heating the thermally expandable composition at a temperature of 180° C. for 30 min.

Preferably, the odor testing is performed according to the VDA 270 method C3, more preferably as described in the experimental section.

The weight ratio of the azodicarbonamide ADCA to the zinc oxide ZnO (ADCA/ZnO) is from 2.0-7.5; and the weight ratio of the azodicarbonamide ADCA to the metal salt of a fatty acid AMS (ADCA/AMS) is from 0.75-6.5.

The preferred thermally expandable compositions and the preferred components ADCA, ZnO, AMS, R and TR are the same as described as being preferred above.

The decrease in the odor formation is compared to a thermally expandable composition mentioned above wherein the weight ratio of the azodicarbonamide ADCA to the zinc oxide ZnO (ADCA ZnO) and/or the weight ratio of the azodicarbonamide ADCA to the metal salt of a fatty acid AMS (ADCA 0 AMS) is outside the mentioned ranges.

### Examples

The followings chemicals shown in Table 1 were used in formulating the thermally expandable compositions.

TABLE 1

| | |
|---|---|
| Solid rubber R1 | Styrene-butadiene rubber, Mooney viscosity 45-55 MU (ML |
| | (1 + 4) 100° C.), styrene content ca. 23 wt.-% |
| Solid rubber R2 | Styrene-butadiene rubber, Mooney viscosity 30-40 MU (ML |
| | (1 + 4) 100° C.), styrene content ca. 23 wt.-% |
| Tackifying resin TR | Wingtack STS, C5 aliphatic hydrocarbon resin, softening point |
| | 90-110° C. (ASTM E 28) |
| Plasticizer PL | Naphtenic oil |
| Styrene block | Styrene-Isoprene-Styrene/Styrene-Isoprene (SIS/SI) Block |
| copolymer SC | Copolymer Blends, styrene content ca. 15 wt.-%, Diblock |
| | content ca. 42 wt.-%, Melt Flow Rate (200° C./5 kg) 25 g/10 min. |
| Filler F1 | Grinded calcium carbonate, d₅₀ particle size 2-10 μm |
| Filler F2 | Perlite-Amorphous Mineral Silicate |
| Accelerator 1 | BIK OT, surface-coated, oil-treated urea |
| ADCA | Unicell D1100, Azodicarbonamide, average particle size (μm) |
| | 9.6-10.0, CAS No. 123-77-3 |
| Vulcanization agent | Tetramethyl thiuram disulfide (TMTD) |
| Accelerator 2 | Mercaptobenzothiazole sulfide (MBTS) |
| ZnO | Zinc oxide |
| AMS | Zinc stearate |
| CaSt | Calcium stearate |
| AlSt | Aluminum stearate |
| POE | POE (Polyolefin elastomer), ethylene-octene copolymer, melt |
| | index in the range of 0.5 to 30 g/10 min (190° C., 2.16 kg). |
| EVA | EVA: Ethylene-vinyl acetate copolymer available under the |
| | trade name of “Ateva 1608” (Celanese) |
| PE | Polyethylene available under the trade name of “LDPE 621i” (Dow) |

### Preparation of the Thermally Expandable Compositions

All inventive (E1 to E7) and non-inventive (Ref.1 to Ref.9) formulations having the compositions as shown in Table 2 were prepared according to the following procedure.

In a first step, the solid rubber SBR was mixed in a sigma blade mixer for 15 min. After that, the fillers, tackifiers and plasticizer are added over a time of 45-60 min. After cooling, the remaining reactive components were added (total weight of the final composition approximately 300 g) and mixed for 30 min. The mixed compositions were then pressed to 2 mm thickness for use (2 mm thickness samples for testing material properties).

### Volume Expansion

The tested formulations were first shaped into form of strips having dimensions 25×25×2 mm (length×width×thickness) and then baked at 160° C., 180° C., 200° C., and 220° C. for 20 or 25 minutes. The volume expansion in percentage was then calculated as: (V_{after}−V_{before})V_{before}. The volumes of the strips before and after the baking process were determined based on density measurements. The densities of the strips were measured according to DIN EN ISO 1183 standard using the water immersion method (Archimedes principle) in deionized water and a precision balance to measure the mass.

### Odor

Odor tests were carried out according to VW specification PV3900 which corresponds to VDA270 method C3. Free foaming samples were prepared in the size needed to achieve a foamed volume of 100 cm3.

The sample dimensions (cm) for 2 L jar/100 ccm was 5.5×9.9. A bake cycle of 30 min @180° C. was used, then the samples were conditioned for 2 hours @80° C. and then cooled for 5 min to 60° C. and the odor was assessed using the following odor scale:
1 Imperceptible
2 Perceptible but not disturbing
3 More perceptible but not disturbing
4 Disturbing
5 Strongly disturbing
6 Unbearable

### Adhesion

Material (approximately 25×100×2 mm thick) was applied on 4×6-inch panels. Substrates evaluated were CRS and HDG oiled with Quaker 61 AUS. Material was placed on the panel and baked at 30 min @170° C. (“Adhesion 170° C.”) and 30 min @190° C. (“Adhesion 190° C.”) and then cooled to room temperature for 4 hours before testing for cohesive failure. The adhesion was evaluated by inserting the top of a sharp spatula under the end of the material strip, and then grasping the tab of the sealer and peeling 180°. The panels were inspected for failure mode—cohesive (“cf”) or adhesive (“af”).

The experimental results are shown in table 3. The weight ratio of zinc oxide to zinc stearate is indicated as “ZnO/AMS”, the weight ratio of azodicarbonamide to zinc oxide is indicated as “ADCA/ZnO”, the weight ratio of azodicarbonamide to zinc stearate is indicated as “ADCA/AMS”, and the weight ratio of azodicarbonamide to the sum of zinc oxide and zinc stearate is indicated as “ADCA/(ZnO+AMS)”.

TABLE 2

| Composition | Ref. | Ref. | | Ref. | | | | | | | Ref. | Ref. | Ref. | Ref. | Ref. | Ref. |
|---|---|---|---|---|---|---|---|---|---|---|---|---|---|---|---|---|
| [wt.-%] | 1 | 2 | E1 | 3 | E2 | E3 | E4 | E5 | E6 | E7 | 4 | 5 | 6 | 7 | 8 | 9 |
| Solid | 5.0 | 5.0 | 5.0 | 5.0 | 5.0 | 5.0 | 5.0 | 5.0 | 5.0 | 5.0 | 5.0 | 5.0 | 5.0 | 0 | 0 | 0 |
| rubber R1 | | | | | | | | | | | | | | | | |
| Solid | 15.0 | 15.0 | 15.0 | 15.0 | 15.0 | 15.0 | 15.0 | 15.0 | 15.0 | 15.0 | 15.0 | 15.0 | 15.0 | 0 | 0 | 0 |
| rubber R2 | | | | | | | | | | | | | | | | |
| Tackifying | 8.0 | 8.0 | 8.0 | 8.0 | 8.0 | 8.0 | 8.0 | 8.0 | 8.0 | 8.0 | 8.0 | 8.0 | 8.0 | 8.0 | 8.0 | 8.0 |
| resin TR | | | | | | | | | | | | | | | | |
| POE | 0 | 0 | 0 | 0 | 0 | 0 | 0 | 0 | 0 | 0 | 0 | 0 | 0 | 20 | 0 | 0 |
| EVA | 0 | 0 | 0 | 0 | 0 | 0 | 0 | 0 | 0 | 0 | 0 | 0 | 0 | 0 | 20 | 0 |
| PE | 0 | 0 | 0 | 0 | 0 | 0 | 0 | 0 | 0 | 0 | 0 | 0 | 0 | 0 | 0 | 20 |
| Plasticizer PL | 26.0 | 26.0 | 26.0 | 26.0 | 26.0 | 26.0 | 26.0 | 26.0 | 26.0 | 26.0 | 26.0 | 26.0 | 26.0 | 26.0 | 26.0 | 26.0 |
| Styrene block | 8.0 | 8.0 | 8.0 | 8.0 | 8.0 | 8.0 | 8.0 | 8.0 | 8.0 | 8.0 | 8.0 | 8.0 | 8.0 | 8.0 | 8.0 | 8.0 |
| copolymer SC | | | | | | | | | | | | | | | | |
| Filler F1 | 22 | 23.5 | 22 | 22 | 20.5 | 19 | 21.5 | 21 | 22 | 19.5 | 17.3 | 22 | 22 | 21.5 | 21.5 | 21.5 |
| Filler F2 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| Accelerator 1 | 4.0 | 4.0 | 4.0 | 4.0 | 4.0 | 4.0 | 4.0 | 4.0 | 4.0 | 4.0 | 4.0 | 4.0 | 4.0 | 4.0 | 4.0 | 4.0 |
| ADCA | 5.0 | 5.0 | 5.0 | 5.0 | 5.0 | 5.0 | 5.0 | 5.0 | 5.0 | 5.0 | 5.0 | 5.0 | 5.0 | 5.0 | 5.0 | 5.0 |
| Vulcanization | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 |
| agent | | | | | | | | | | | | | | | | |
| Accelerator 2 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| ZnO | 2.5 | 1 | 1 | 0.5 | 1 | 1 | 1.5 | 2 | 1.5 | 2.5 | 3.6 | 1 | 1 | 1.5 | 1.5 | 1.5 |
| AMS | 0 | 0 | 1.5 | 2 | 3 | 4.5 | 1.5 | 1.5 | 1 | 2.5 | 3.6 | 0 | 0 | 1.5 | 1.5 | 1.5 |
| CaSt | 0 | 0 | 0 | 0 | 0 | 0 | 0 | 0 | 0 | 0 | 0 | 1.5 | 0 | 0 | 0 | 0 |
| AlSt | 0 | 0 | 0 | 0 | 0 | 0 | 0 | 0 | 0 | 0 | 0 | 0 | 1.5 | 0 | 0 | 0 |
| Total | 100 | 100 | 100 | 100 | 100 | 100 | 100 | 100 | 100 | 100 | 100 | 100 | 100 | 100 | 100 | 100 |
| (wt.-%) | | | | | | | | | | | | | | | | |

TABLE 3

| | Ref. | Ref. | | Ref. | | | | |
|---|---|---|---|---|---|---|---|---|
| Composition | 1 | 2 | E1 | 3 | E2 | E3 | E4 | E5 |
| Vol Expansion | 564 | 316 | 433 | 129 | 437 | 413 | 653 | 492 |
| 180 C. × | | | | | | | | |
| 30 min (%) | | | | | | | | |
| Odor | 3.4 | 3.7 | 2.2 | 3 | 2.25 | 2.3 | 2 | 3 |
| Adhesion | n.d | n.d | n.d | n.d | n.d | n.d | cf/af | n.d |
| 170° C. | | | | | | | | |
| (CRS/HDG) | | | | | | | | |
| Adhesion | n.d | n.d | n.d | n.d | n.d | n.d | cf/cf | n.d |
| 190° C. | | | | | | | | |
| (CRS/HDG) | | | | | | | | |
| ZnO/AMS | 2 | — | 0.67 | 0.25 | 0.33 | 0.22 | 1.00 | 1.33 |
| ADCA/ZnO | 2.00 | 5.00 | 5.00 | 10.00 | 5.00 | 5.00 | 3.33 | 2.50 |
| ADCA/AMS | — | — | 3.33 | 2.50 | 1.67 | 1.11 | 3.33 | 3.33 |
| ADCA/(ZnO + | 2.00 | 5.00 | 2.00 | 2.00 | 1.25 | 0.91 | 1.67 | 1.43 |
| AMS) | | | | | | | | |
| | | | Ref. | Ref. | Ref. | Ref. | Ref. | Ref. |
| Composition | E6 | E7 | 4 | 5 | 6 | 7 | 8 | 9 |
| Vol Expansion | 613 | 668 | 630 | 321 | 173 | 244 | 690 | 489 |
| 180 C. × | | | | | | | | |
| 30 min (%) | | | | | | | | |
| Odor | 3 | 3.4 | 4.6 | 2.9 | 2.1 | 5.7 | 4.4 | 4.0 |
| Adhesion | cf/cf | n.d | n.d | n.d | n.d | n.d | n.d | n.d |
| 170° C. | | | | | | | | |
| (CRS/HDG) | | | | | | | | |
| Adhesion | cf/cf | n.d | n.d | n.d | n.d | n.d | n.d | n.d |
| 190° C. | | | | | | | | |
| (CRS/HDG) | | | | | | | | |
| ZnO/AMS | 1.50 | 1.00 | 1.00 | — | — | 1.00 | 1.00 | 1.00 |
| ADCA/ZnO | 3.33 | 2 | 1.38 | 5.00 | 5.00 | 3.33 | 3.33 | 3.33 |
| ADCA/AMS | 5.00 | 2 | 1.38 | — | — | 3.33 | 3.33 | 3.33 |
| ADCA/(ZnO + | 2.00 | 1.0 | 0.7 | 5.00 | 5.00 | 1.67 | 1.67 | 1.67 |
| AMS) | | | | | | | | |

1. A thermally expandable composition comprising:
a) At least one solid rubber R,
b) At least one tackifying resin TR,
c) azodicarbonamide ADCA
d) zinc oxide ZnO
e) at least one metal salt of a fatty acid AMS containing 16 C-atoms or 18 C-atoms, wherein the metal is zinc,
wherein the weight ratio of the azodicarbonamide ADCA to the zinc oxide ZnO (ADCA/ZnO) is from 2.0-7.5;
and wherein the weight ratio of the azodicarbonamide ADCA to the metal salt of a fatty acid AMS (ADCA/AMS) is from 0.75-6.5.

2. The thermally expandable composition according to claim 1, wherein the weight ratio of the azodicarbonamide ADCA to the zinc oxide ZnO (ADCA/ZnO) is from 2.25-6.0.

3. The thermally expandable composition according to claim 1, wherein the weight ratio of the azodicarbonamide ADCA to the metal salt of a fatty acid AMS (ADCA/AMS) is from 1.0-6.0.

4. The thermally expandable composition according to claim 1, wherein the weight ratio of the azodicarbonamide ADCA to the sum of the zinc oxide ZnO and the at least one metal salt of a fatty acid AMS (ADCA/(ZnO+AMS)) is from 0.75-6.5.

5. The thermally expandable composition according to claim 1, wherein the weight ratio of the zinc oxide ZnO to the at least one metal salt of a fatty acid AMS (ZnO/AMS) is from 0.2-2.0.

6. The thermally expandable composition according to claim 1, wherein the weight ratio of the at least one solid rubber R to the azodicarbonamide ADCA is from 2.0-6.0.

7. The thermally expandable composition according to claim 1, wherein the thermally expandable composition contains less than 5 wt.-%, of at least one epoxy resin, based on the total weight of the thermally expandable composition.

8. The thermally expandable composition according to claim 1, wherein the at least one solid rubber R is selected from the group consisting of butyl rubber, halogenated butyl rubber, styrene-butadiene rubber (SBR), ethylene-propylene rubber (EPR), ethylene-propylene diene monomer rubber (EPDM), natural rubber, cis-1,4-polyisoprene, and polybutadiene rubber.

9. The thermally expandable composition according to claim 1, wherein the at least one solid rubber R comprises 5-40 wt.-%, of the total weight of the thermally expandable composition.

10. The thermally expandable composition according to claim 1, wherein the at least one tackifying resin TR comprises 2-20 wt.-%, of the total weight of the thermally expandable composition.

11. The thermally expandable composition according to claim 1, further comprising a vulcanization system VS, wherein the vulcanization system VS is a vulcanization system without elementary sulfur containing at least one vulcanization agent selected from the group consisting of para-quinone dioxime, para-benzoquinone dioxime, para-quinone dioxime dibenzoate, tetramethyl thiuram disulfide (TMTD), and tetrabenzylthiuram disulfide (TBzTD).

12. The thermally expandable composition according to claim 1, wherein the thermally expandable composition, besides the c) azodicarbonamide ADCA, is free of physical and chemical blowing agents.

13. A baffle element for open or hollow structures, wherein the element comprises the thermally expandable composition according to claim 1.

14. The baffle element according to claim 13, wherein the thermally expandable composition has a sheet-like structure.

15. A method for sealing and/or baffling a cavity or hollow structure, wherein the baffle element according to claim 13 is introduced into the cavity or hollow structure and subsequently thermally expanded such that the cavity or hollow structure is at least partially filled by the expanded composition.

16. (canceled)
